(19) United States
(12) Patent Application Publication
(10) Pub. No.: US 2005/0226765 A1
(43) Pub. Date: Oct. 13, 2005

(54) Analyte detection system

(75) Inventors: Joanne Rosamond Bone, Leicestershire (GB); Roger Malcolm Smith, Leicestershire (GB); Barry Leonard Sharp, Leicestershire (GB)

Correspondence Address: James E Bradley;Bracewell & Patterson, P O Box 61389, Houston, TX, 77208-1389, US

(73) Assignee: Phlogiston Scientific Limited, Loughborough, Leicestershire (GB)

(21) Appl. No.: 10/362,983

(22) PCT Filed: Aug. 17, 2001
(86) PCT No.: PCT/GB01/03728

§ 371 Date: Jun. 26, 2003

(30) Foreign Application Priority Data
Sep. 2, 2000 (GB) 0021567.3
Sep. 26, 2000 (GB) 0023504.4

(51) Int. Cl. G01N 27/00

(52) U.S. Cl. 422/54

(57) ABSTRACT

There is disclosed an analyte detection system comprising: and analyte analysis stage through which a condensed phase containing the analyte flows; nebuliser means into which the output of the analyte analysis stage is introduced, the nebuliser means producing an analyte containing aerosol; a flame based analyte detector, and means for introducing the analyte containing aerosol into said flame based anylte detector; in which the condensed phase produces no or negligible response from flame based analyte detector, and I) the system can operate at condensed phase flow rates of greater than 20 μl min⁻¹, preferably greater than 50 μl min⁻¹, most preferably greater than 100 μl min⁻¹; and/or ii) the means for introducing the analyte containing aerosol into said flame based detector comprises a spray chamber

This invention relates to an analyte detection system, in particular to a “universal” detection system in which an analyte analysis stage, such as a liquid chromatography stage, is interfaced to a flame based detector, such as a flame ionisation detector (FID).

Traditionally, the direct detection of compounds (analytes) dissolved in flowing liquid streams, such as the eluent from liquid chromatography, or the effluent from flow injection analyses, has generally depended on spectroscopic methods, usually ultraviolet or fluorescence spectroscopy. These widely used approaches require the presence in the analyte of a chromophore or fluorophore. However, many compounds of interest produce only a low response or a negligible response using such detection methods. In addition many compounds which provide a signal can generate very different mass responses (i.e., large differences in the magnitude of the output signal for the same amount of analyte, because of differences in extinction coefficients) so that direct individual calibration of the detector is required.

A wider response can be obtained by using a mass spectrometry as a detector, but currently liquid chromatography-mass spectrometry linked systems (LC-MS) are rather expensive and would normally not be employed for routine analyses. Similarly, the sample can be passed to a plasma torch (an inductively coupled plasma-ICP), where an element specific response can be obtained by emission (ICP-Emission) or mass spectrometry (ICP-MS), but again this is a relatively expensive method and is primarily applicable to analytes containing metal atoms rather than organic compounds. In each case the sample has to be evaporated, sprayed or nebulised into the gas phase so that it can be introduced into the detection cell or plasma.

Ever since liquid chromatographic methods have been employed, there has been a need for a so-called “universal detector”, which could provide a response which ignored the eluent mobile phase but detected the dissolved analytes and gave a similar signal magnitude for similar quantities of each analytes in a mixture.

Previously reported broadly applicable or universal detection methods have primarily been based on the measurement of changes in the refractive index (RI) of the eluent, which tends to be a relatively insensitive method, because it depends on the measurement of small changes in the bulk properties of the eluent. The alternative approach has been the light scattering detector (LSD) (or mass evaporative detector), in which the eluent is sprayed into a chamber using an inert gas and the solvent is evaporated from the droplets leaving particles of involatile analytes. These pass through a light beam from a lamp or laser and the scattered light is detected. This detector has some limitations, since the response can be non-linear as it depends on particle size. This detector has the disadvantage that volatile components of the analyte mixture are usually lost together with the solvent so that only higher molecular weight analytes or involatile components can be detected.

The primary alternative group of methods have employed variants of the “transport” detector, which involve a step in which eluent is lost or hidden during the transport of the analyte from the end of the separation system to the detection step. The effluent is deposited on either a moving chain, moving belt, moving wire, rotating disc or helical wire and the solvent is evaporated (usually thermally and/or under a reduced pressure), leaving the analyte to be transported to the detection step. The detector in these cases is usually a flame ionisation detector (FID) or mass spectrometer (MS). Both of these detectors provide a broadly universal response for those organic analytes which reach the detector. Unfortunately, problems with the transport detectors, such as inhomogeneous sampling, loss of volatile analytes during solvent evaporation, spiking due to sample diffusion on the hot metal conveyors causing an increase in background noise and ghost peaks due to incomplete removal of analyte from reusable conveyor systems have limited their application. The mass spectrometer and flame ionisation detectors both provide a high energy to the analytes breaking them down to form ions, which can be detected as a current flowing across a potential difference. The primary difference is in the complexity of the system, the amount of information determined and hence the cost.

The linkage of liquid chromatography (LC) to a FID (a detector commonly associated with gas chromatography) is highly attractive, as the detector is much simpler to manufacture and operate than a mass spectrometer. Also, the FID has a high sensitivity, is capable of detecting both volatile and non-volatile species, and does not require a chromophore. The detector response is highly linear over a wide range of sample masses and most organic compounds will have a similar mass response, although compounds which do not burn are generally not detected. However, the application of FID to LC has been limited because most separations employ mixtures of an organic solvent (or solvents) and water as the eluent and the former causes a high background signal in the detector as it can burn. Hence, transport detectors of the type discussed above have been employed to remove the mobile phase before the detection step. The FID is well known as the most successful universal detector in gas chromatography where the inorganic carrier gas produces no response, but gas chromatography is limited to volatile and thermally stable analytes.

In the last few years, superheated (subcritical) water has been employed as the sole liquid component of the mobile phase for liquid chromatography, leading to a number of attempts to directly link the chromatographic separation stage to a flame ionisation detector. Superheated water is produced when water is heated at temperatures above 100° C. under sufficient pressure to remain as a liquid. Under such conditions, it can mimic the elution characteristics of organic solvents and organic/aqueous mixtures. Furthermore, superheated water produces a negligible background response from the FID.

Published work has employed two main approaches. The first method is effectively based on the well known thermospray concept often used in early LC-MS coupling (Miller, D. J. and Hawthorne, S. B., Anal. Chem., 69 (1997) 623; Smith, R. M.; Burgess, R J.; Chienthavom, O.; Stuttard, J. R., LC-GC International, 12 (1999) 30; Ingelse, B. A.; Janssen, H. G.; Cramers, C. A., HRC-Journal of High Resolution Chromatography, 21 (1998) 613). These approaches employed a heated capillary tube, usually metal or glass, placed within the flame jet of the GC or very close to it. Generally a high temperature of about 300-400° C. is used causing the eluting liquid to flash-evaporate, thereby spraying any volatile components into the flame of the FID, where organic analytes burn generating a conventional signal. Additionally, the capillary often provides a back-pressure to the chromatographic system. A slightly different approach has been to use a commercially available eluent jet interface (Hooijschuur, E. W. J.; Kientz, C. E.; Brinkman, U. A., Th. J. High Res. Chrom., 23 (2000) 309). In this design the capillary contains a restriction close to the tip, which is inductively heated using 80-90W, thus producing a sharp temperature gradient.

Both these concepts are based on heating the aqueous solution to generate steam to transport the analyte into the gas phase and hence to the detection flame. A disadvantage with these systems is that if the analyte is involatile or thermally unstable, it can be deposited or degraded and may rapidly block the capillary, thus reducing spray efficiency. This appears to limit the useful response to analytes which are thermally stable and volatile. The main problem associated with these interfaces are the lack of reliability and robustness of the instrumentation.

Hooijschuur et al, ibid, also describes a comparison experiment in which an interface based on a microjet nebuliser is employed. In fact, it is this comparison experiment which, with hindsight, bears the closest similarity to the present invention. However, Hooijischuur et al is quite negative in its assessment of this nebuliser based technique, and compares the nebuliser based technique unfavourably with the eluent evaporation technique, which is the main thrust of Hooijschuur et al.

Furthermore, this comparison experiment is not a practical routine system, inter alia because a micro capillary liquid chromatography (LC) system is employed, together with a micro capillary linking the LC system to the nebuliser, thus limiting flow rates and hence sensitivity. Flow rates of 10 μl min⁻¹ are reported. A further problem is that, even if higher flow rates were contemplated, condensed liquid would drain to the bottom of the detector and be blown through the flame causing considerable noise. A third problem is that if larger aerosol droplets are formed, they can cause spiking in the flame, since such larger droplets are not prevented from travelling from the nebuliser to the flame. A fourth problem is the rather cumbersome arrangement of the comparison experiment in which, apparently, the FID is positioned inverted below the nebuliser. It must be emphasised that this experiment was used for comparison purposes with the heated capillary technique which is the principal concern of Hooijschuur et al., and the comparison was unfavourable towards the nebulisation technique. Thus the prior art in which the use of superheated water is combined with FID detection clearly points the skilled person towards flash evaporation of the eluent.

Further prior art is discussed below. GB 1475432 discloses an interface for liquid chromatography in which an oscillator is used to atomise the eluent from a chromatographic column. U.S. Pat. No. 5,153,673 discloses a pulsed flame detector for use with numerous samples. U.S. Pat. No. 3,967,931 discloses a system in which the eluent from a liquid chromatography column is aspirated directly into a flame, thereby producing an aerosol in situ within the flame. A problem associated with this approach is that non-volatile analytes can be degraded, causing depositions and possible blockages.

The present invention overcomes the aforesaid problems and disadvantages, and provides a practical, cost-effective “universal” detector.

According to a first aspect of the invention there is provided an analyte detection system comprising:
an analyte analysis stage through which a condensed phase containing the analyte flows;
nebuliser means into which the output of the analyte analysis stage is introduced, the nebuliser means producing an analyte containing aerosol;
a flame based analyte detector; and
means for introducing the analyte containing aerosol into said flame based analyte detector;
in which: the condensed phase produces no or negligible response from flame based analyte detector; and
i) the system can operate at condensed phase flow rates of greater than 20 μl min⁻¹, preferably greater than 50 μl min, most preferably greater than 100 μl min⁻¹;
and/or ii) the means for introducing the analyte containing aerosol into said flame based detector comprises a spray chamber.

By providing systems having this combination of features, it is possible to produce a so-called “universal” detector which can be used to detect organic and inorganic compounds, irrespective of whether the compounds are volatile or non-volatile. Additionally, elements can be detected. Furthermore, the system is practical and cost effective. Furtherstill, the provision of nebulisation means as a way of producing an aerosol removes the problems of deposition, decomposition and blockage associated with high temperature evaporative methods, since nebulisation takes place at a temperature substantially below the boiling point of the condensed phase.

The condensed phase may be aqueous, and may be an aqueous solution. In a preferred embodiment, the condensed phase is a super heated aqueous solution. It is possible to include other components such as inorganic buffers, ion-pair reagents, acids, bases and organic additives such as formic acid or trifluoroacetic acid provided that such components give rise to no or negligible signal from the detector. Other possible solvents are carbon tetrachloride, Freons such as 124a, and subcritical carbon dioxide.

The condensed phase may be a supercritical fluid, such as carbon dioxide, xenon, argon, ammonia and nitrous oxide.

The condensed phase may be a superheated liquid phase, such as carbon dioxide or, as mentioned above, water.

The detector may be a FID. This has the advantage of providing a linear response over a wide analyte mass range, and is relatively inexpensive.

The detector may be a thermionic detector, pulsed flame photometric detector or flame photometric detector.

The analyte analysis stage may comprise an analyte separation stage, in which instance effluent from the analyte separation stage is introduced into the nebulisation means.

The analyte separation stage may comprise a liquid chromatographic stage.

The analyte separation stage may comprise a capillary electrophoresis, electrochromatographic or capillary electrochromatographic stage.

Alternatively, the analyte stage many comprise a flow injection analysis stage.

The system may comprise a spray chamber in which separation of the aerosol is achieved so that larger aerosol droplets are not introduced to the flame based analyte detector. The spray chamber may be adapted to create turbulence in the flow of the aerosol. By removing larger droplets, noise from the detector is reduced.

The spray chamber may be adapted so as to cause the aerosol to flow in a centrifugal flow pattern.

According to a second aspect of the invention there is provided the use of a system as according to the first aspect of the invention to detect volatile and non-volatile compounds or elements.

According to a third aspect of the invention there is provided the use of a system according to the first aspect of the invention to detect organic compounds.

According to a fourth aspect of the invention there is provided the use of a system according to the first aspect of the invention to detect inorganic compounds.

Systems and uses in accordance with the invention will now be described with reference to the accompanying drawings, in which:

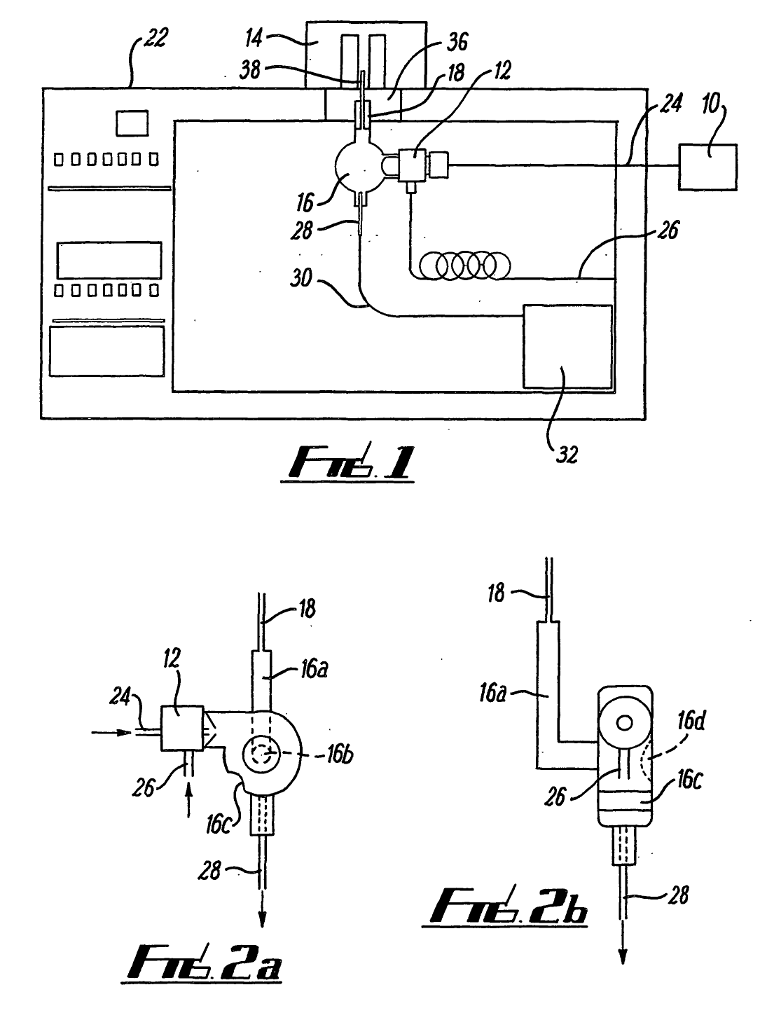

FIG. 1 is a front view of an embodiment of a liquid chromatography system in accordance with the invention;

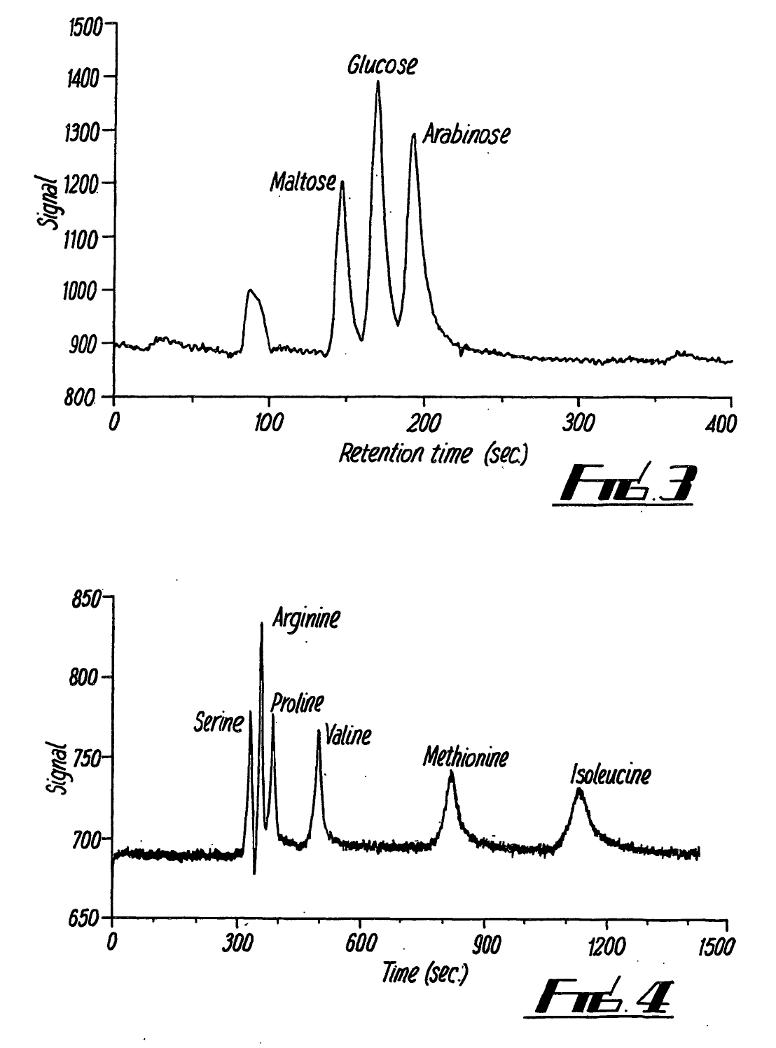

FIG. 2 shows a) front and b) side views of the spray chamber of FIG. 1;

FIG. 3 is a chromatogram showing carbohydrate separation;

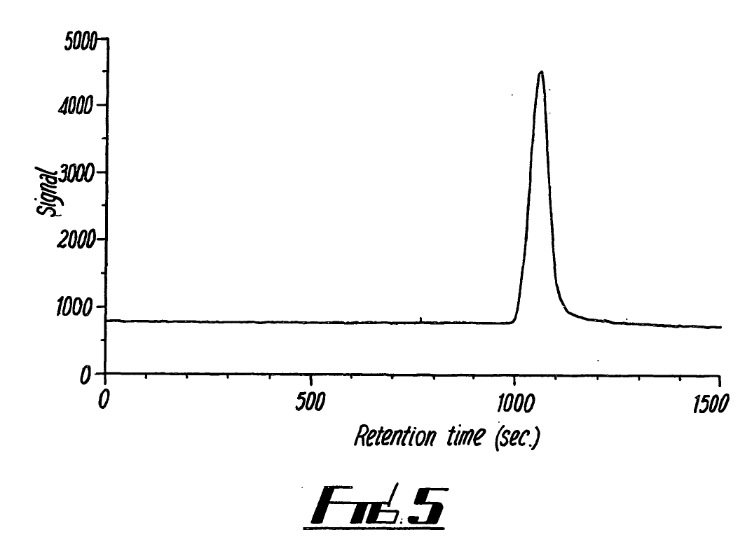

FIG. 4 is a chromatogram showing amino acid separation; and

FIG. 5 is a chromatogram showing benzaldehyde detection using superheated water as an eluent.

FIG. 1 shows an analyte detection system comprising:
a separation stage (shown generally at 10) through which a condensed phase containing the analyte flows;
nebuliser means 12 into which the flowing condensed phase is introduced, the nebuliser means 12 producing an analyte containing aerosol;
a flame based analyte detector 14; and
means 16, 18 for introducing the analyte containing aerosol into said flame based analyte detector 14;
in which the condensed phase produces no or negligible response from flame based analyte detector 14; and
   i) the system can operate at condensed phase flow rates of greater than 20 μl min⁻¹, preferably greater than 50 μl min⁻¹, most preferably greater than 100 μl min⁻¹;
and ii) the means 16, 18 for introducing the analyte containing aerosol into said flame based detector 14 comprises a spray chamber 16.

The system further comprises a box/oven (which can maintain a temperature controlled environment) 22 containing the detection system, which is securely mounted to increase stability. The condensed phase flow enters a microconcentric nebuliser 12 through a narrow bore tube 24, and the liquid is sprayed into a cyclonic spray chamber 16 with a nebuliser gas, introduced via gas conducting conduit 26. The nebuliser gas can be any suitable inert gas such as nitrogen or argon. The cyclonic spray chamber 16 has a liquid drain 28 and connecting tubing 30, which can be connected to a extraction peristaltic pump 32 or similar device to remove any condensed liquid. The aerosol spray thus formed exits the cyclonic chamber 16 at side arm outlet 16a and passes into the bottom end of a connecting tube 18. The connecting tube 18 can be formed from any suitable material, such as steel or glass. Furthermore, the connection between the spray chamber 16 and connecting tube 18 does not have to be permanent, and in fact the system may be demountable. The connecting tube 18 passes through a heated block 36 and introduces the aerosol to the jet 38 of the flame detector 14. The heater block 36 can be controlled up to a temperature of 450° C., although the exact limit is not critical and may be largely in line with current FID designs. In fact, block temperatures in excess of conventionally used temperatures might be utilised in conjunction with the present invention. Hydrogen is added to the aerosol flow at a similar point to that of a conventional FID, but a higher flow rate of hydrogen than is usual is required if the condensed phase is aqueous, because the aqueous aerosol flow cools the flame. This necessitates a relatively high hydrogen flow, and the use of wider than normal mixing slots. A hydrogen flow rate of ca. 100 ml min⁻¹ has been found to be suitable, although it is unlikely that this value is a critical one. The jet of the flame based detector 14 comprises a wide bore alumina tube 38. It is also possible to use a different ceramic or another material. The internal diameter of the alumina tube 38 is ca. 1.5 mm, although a wider range of internal diameters, perhaps 1 to 3 mm, could be used depending on the gas flow employed.

Air is added around the flame as in conventional FID systems in order to maintain combustion. Flow rates are generally higher than in conventional FIDs; a representative value is 500 ml min⁻¹. A detection signal is generated by maintaining a potential difference of ca. 170V between the jet and a collector (not shown).

In a representative, but non-limiting, example the analyte is dissolved in an aqueous solution which is introduced into the nebuliser at a flow rate of between 0.01 and 1.0 ml min⁻¹ through a capillary tube. Higher flow rates, up to ca 3.0 ml min⁻¹, might be contemplated. A typical flow rate of nebuliser gas is ca. 400 ml min⁻¹. The aqueous solution can contain limited quantities of dissolved inorganic salts, acids or bases to control pH and perform other known functions, provided that these additives do not result in any significant interfering signal from the FID.

The spray chamber 16 is an expansion chamber which is shown in more detail in FIG. 2, in which like numerals are used to denote features which are identical to features shown in FIG. 1. The spray chamber 16 contains a centrifugal flow path from the periphery where the effluent flow enters to the central exit 16b, coupled with a flow dimple 16c which creates turbulence in the flow, thereby breaking up laminar flow so that larger droplets (which might cause spiking in the flame) hit the walls and are lost, exiting via drain 28. Other ways of creating turbulence would readily present themselves to the skilled person. A second flow dimple 16d is disposed opposite the exit 16b. The configuration of the spray chamber is generally as described in Taylor et al, Journal of Analytical Atomic Spectrometry, 13 (1998) 1095-1100.

Water has been used in the separation stage as the condensed phase from ambient temperature up to ca. 250° C. When the separation temperature is greater than 100° C. (superheated conditions), the condensed phase can be produced by generating a back-pressure using a restriction in the tubing after the separation stage, so that the water is below its boiling point when the water reaches the nebulisation means. Other ways of creating the back pressure include a frit or a mechanically operated solenoid. However, it should be noted that the condensed phase will not be at such elevated temperatures when it reaches the nebulisation means. In fact, the condensed phase will be at a temperature substantially below boiling point.

Furthermore, it should be noted that the temperature encountered by the effluent at the nebuliser means is substantially less than the boiling point of the condensed phase. This overcomes a disadvantage of thermospray type interfaces, namely that involatile or thermally unstable analytes can be degraded or deposited and thus block the spray capillary. It is possible to maintain the nebuliser means at a constant, but relatively low, temperature for stability purposes. In the case of water, the nebulisation means would be maintained at the temperature of 50° C. or less.

The separation stage 10 is a LC system, although it is possible to utilise other separation stages such as capillary electrophoresis, electrochromatographic and capillary electrochromatographic stages. Other analyte analysis stages, such as flow injection analysis, might be used in place of a separation stage. Various LCs can be used in conjunction with the present invention: in particular, it is recognised that the internal diameters and internal volumes of the LC and the conduit which conveys the condensed phase to the nebuliser are advantageously large enough to support flow rates in excess of 20, preferably greater then 50, most preferably greater than 100 μl min⁻¹. This is in contrast to the technique described in Hooijschuur et al.

In a specific embodiment, an LC system was constructed using a number of modular components. A Rheodyne 7161 injector was employed, and the mobile phase was pumped using a Jasco PU980 pump. Columns from a range of manufacturers were used, having different internal diameters from 2 mm to 4.6 mm, and lengths between 100 and 250 mm. The columns were packed with a number of different stationary phases. The columns were heated in either a Jones Chromatography Column oven (for the temperatures up to 100° C.) or a Pye Unicam 104 GC oven for higher temperatures (or if temperature gradients are employed). Optionally, a HPLC type UV spectroscopic detector could be placed between the column and the FID. A CETAC MCN-100-microconcentric nebuliser was employed (CETAC Technologies, Omaha, USA), although other nebulisers might be advantageously employed instead.

FIGS. 3 to 5 show chromatograms obtained in a number of experiments, using the apparatus of the specific embodiment. FIG. 3 shows the separation of the carbohydrate maltose, glucose and arabinose using aqueous solution at 35° C. and a flow rate of 0.5 ml min⁻¹. FIG. 4 shows the separation of the amino acids serine, arginine, proline, valine, methionine and isoleucine using aqueous solution (with 0.02% trifluoroacetic acid) at ambient temperature and a flow rate of 0.5 ml min⁻¹. It is not possible to achieve these carbohydrate and amino acid separations using gas chromatography owing to the involatility of the species. HPLC is not easy to perform because these species lack chromophores which are required for spectroscopic detection. FIG. 5 shows the separation of benzaldehyde using superheated water at 200° C. and a flow rate of 0.2 ml min⁻¹.

In comparison to the nebuliser “comparison” experiment of Hooijschuur et al, the present system has the advantage of being able to handle much higher liquid flow rates, thereby increasing the versatility and sensitivity of the system. Furthermore, a higher nebuliser gas flow is used. This has the consequence that the gas flow itself, rather than gravity, is used to transport the aerosol droplets to the detector flame, thereby permitting the detector to be mounted in the conventional manner, above the aerosol introduction point, rather than in the inverted configuration of Hooijschuur et al. Furtherstill, the provision of the spray chamber provides advantages in terms of draining excess liquid and removing larger aerosol droplets. However, it is possible that other nebulisation systems might be advantageously employed within systems of the present invention without necessitating the provision of a spray chamber.

1. An analyte detection system comprising:
an analyte analysis stage through which a condensed phase containing the analyte flows;
nebuliser means into which the output of the analyte analysis stage is introduced, the nebuliser means producing an analyte containing aerosol;
a flame based analyte detector; and
means for introducing the analyte containing aerosol into said flame based analyte detector; and
i) the sytems can operate at condensed phase flow rates of greater than 20 μl min⁻¹, preferably greater than 50 μl min⁻¹, most preferably greater than 100 μl min⁻¹;
and/or ii) the means for introducing the analyte containing aerosol into said flame based detector comprises a spray chamber.

2. An analyte detection system according to claim 1 in which the condensed phase is aqueous.

3. An analyte detection system according to claim 2 in which the condensed phase is an aqueous solution.

4. An analyte detection system according to claim 3 in which the condensed phase is a superheated aqueous solution.

5. An analyte detection system according to claim 1 in which the condensed phase is a supercritical fluid.

6. An analyte detection system according to claim 1 in which the condensed phase is a superheated liquid phase.

7. An analyte detection system according to claim 1 in which the detector is a flame ionisation detector.

8. An analyte detection system according to claim 1 in which the detector is a thermionic detector, pulsed flame photometric detector or flame photometric detector.

9. An analyte detection system according to claim 1 in which the analyte analysis stage comprises an analyte separation state and effluent from the analyte separation stage is introduced into the nebulisation means.

10. An analyte detection system according to claim 9 in which the analyte separation stage comprises a liquid chromatographic stage.

11. An analyte detection system according to claim 9 in which the separation stage comprises a capillary electrophoresis, electrochromatographic or capillary electrochromatographic stage.

12. An analyte detection system according to claim 1 in which the analyte analysis stage comprises a flow injection analysis stage.

13. An analyte detection system according to claim 1 in which the system comprises a spray chamber in which separation of the aerosol is achieved so that larger aerosol droplets are not introduced to the flame based analyte detector.

14. An analyte detection system according to claim 13 in which the spray chamber is adapted to create turbulence in the flow of the aerosol.

15. An analyte detection sytem according to claim 13 or claim 14 in which the spray chamber is adapted so as to cause the aerosol to flow in a centrifugal flow pattern.

16. Use of a system according to claim 1 to detect volatile and non-volatile compounds or elements.

17. Use of a system according to claim 1 to detect organic compounds.

18. Use of a system according to claim 1 to detect inorganic compounds.
